(19) United States
(12) Patent Application Publication
(10) Pub. No.: US 2005/0080927 A1
(43) Pub. Date: Apr. 14, 2005

(54) Method and apparatus for managing IP addresses and name mappings for wireless clients

(75) Inventors: Ray W. Anderson, Liberty Hill, TX (US); David ZhiWei Dai, Austin, TX (US); Vasu Vallabhaneni, Austin, TX (US); Patrick Tam Vo, Houston, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/682,417

(22) Filed: Oct. 9, 2003

(51) Int. Cl. G06F 15/16

(52) U.S. Cl. 709/245

(57) ABSTRACT

A method, apparatus, and computer instructions for managing network addresses. A received network address from a current server is compared for use in identifying the data processing system with a prior network address from a previous server. A release data packet is created if the received network address is a new network address and the previous server is a different server than the current server in which the release data packet includes the prior network address. The release data packet is sent to the previous server in which the release data packet causes the previous server to release the prior network address for reuse.

### BACKGROUND OF THE INVENTION

1. Technical Field

The present invention relates generally to an improved data processing system, and in particular, to a method and apparatus for managing Internet Protocol (IP) addresses. Still more particularly, the present invention relates to a method, apparatus, and computer instructions for cleaning up unused IP addresses and name mappings for wireless clients.

2. Description of Related Art

Data processing systems connected to a network are assigned unique addresses to allow for communications between the systems. These addresses also are referred to as an IP addresses. One way of adding a data processing system to a network is for a user or administrator to manually assign and configure IP addresses. Previously, for example, a computer user had to request an address and then a system administrator would manually configure the data processing system for the user.

Mistakes in the configuration process are easy to make with a manual process. For example, if the same IP address is assigned to more than one data processing system, all but one of those data processing systems will have problems connecting to the network. Also, when mobile users travel between different sites, these users are required to reconfigure and set up an IP address for each different site from which they connect.

Dynamic host configuration protocol (DHCP) is a protocol that lets network administrators to centrally manage and automate the assignment of IP addresses and configurations on a network. This protocol avoids having users and administrators manually enter IP addresses for each data processing system. Further, IP addresses may be distributed and supervised from a central point with this protocol. In this manner, DHCP provides for automatic dynamic allocation of IP client configurations for a specific period of time, called a lease period.

When a DHCP client restarts, whether from a power off or a reset, this client tries to obtain the same IP address that the client had before the down state. The IP address that the DHCP client had last used is broadcast as a DHCP request on a local subnet. This broadcast is a way for the client to ask whether the client may reuse this address or can any listening DHCP server provide the client a new IP address if the old address is already taken. These types of broadcasts from clients, however, are automatically dropped by routers.

This type of implementation is fine for stationary DHCP clients because a DHCP server is present on the subnet, but does not work well for wireless clients. When a wireless DHCP client migrates between different zones, controlled by different domain name servers and DHCP servers, the wireless client leaves behind resources that will not be reclaimed until a defined expiration time. This defined expiration time is the lease time for the client's IP address. These resources include the IP address obtained by the client from the DHCP server and any name/address mapping stored in a domain name system (DNS) server. The broadcast made by the DHCP wireless client is not received by the previous DHCP server because all broadcast packets are dropped by routers. As a result, the previous DHCP server has no way to be informed that the address may be reclaimed for other uses.

The DHCP server will not reclaim the IP address until the lease time has expired. It is not uncommon to have a DHCP server with an IP address pool that has a lease time of three days. The amount of time that the name/address is valid in a domain name server coincides with the lease time. When a client obtains an IP address, the client also may include a name used to reach the client. The DHCP server sends this name/address mapping to a domain name server, which will store this mapping in a set of domain name service (DNS) entries. As a result, name/address mapping entries may be present that are no longer valid when a wireless client moves and receives a new IP address and name/address mapping.

One possible solution to this portion is to decrease the lease time. This option has costs and benefits. Decreasing the lease time allows for quicker reclaiming of addresses, but increases the load on the DHCP server. The increased new load on the server is caused by wireless or other types of mobile clients as well as stationary clients. Another solution is to implement subnetting in which wireless clients use one pool of IP addresses while stationary clients use a different pool of IP addresses. This solution serves to decrease the total number of available IP addresses per subnet, but the load still remains high on the server. As a result, finding optimal lease time for a smaller pool of IP addresses without placing high loads on a DHCP server is difficult.

Therefore, it would be advantageous to have an improved method, apparatus, and computer instructions for managing IP addresses and name mappings for mobile clients.

### SUMMARY OF THE INVENTION

The present invention provides a method, apparatus, and computer instructions for managing network addresses. A received network address from a current server is compared for use in identifying the data processing system with a prior network address from a previous server. A release data packet is created if the received network address is a new network address and the previous server is a different server than the current server in which the release data packet includes the prior network address. The release data packet is sent to the previous server in which the release data packet causes the previous server to release the prior network address for reuse.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram illustrating components used in managing IP address and domain name service entries in accordance with a preferred embodiment of the present invention; and

FIG. 5 is a flowchart of a process for requesting and managing IP addresses from a DHCP server in accordance with a preferred embodiment of the present invention.

### DETAILED DESCRIPTION OF THE PREFERRED EMBODIMENT

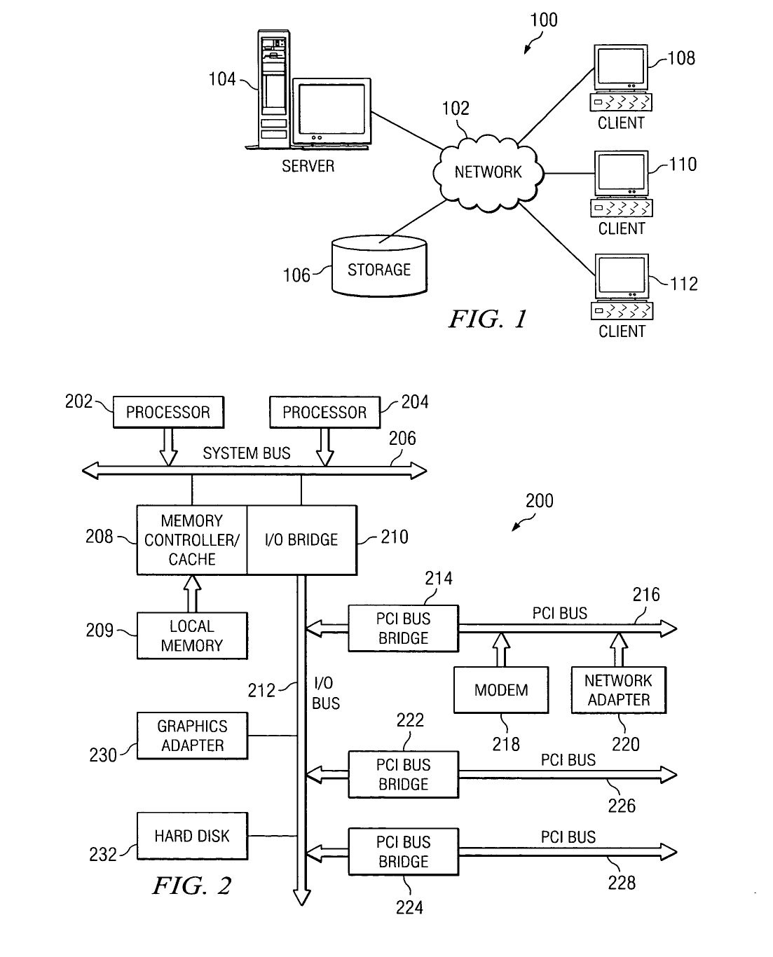

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers.

In the depicted example, server 104 provides data, such as boot files, operating system images, and applications to clients 108-112. Clients 108, 110, and 112 are clients to server 104. In the illustrative examples, server 104 may act as a DHCP server and/or a domain name system server. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may function as either or as both a DHCP server and a DNS server depending on the particular implementation.

Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

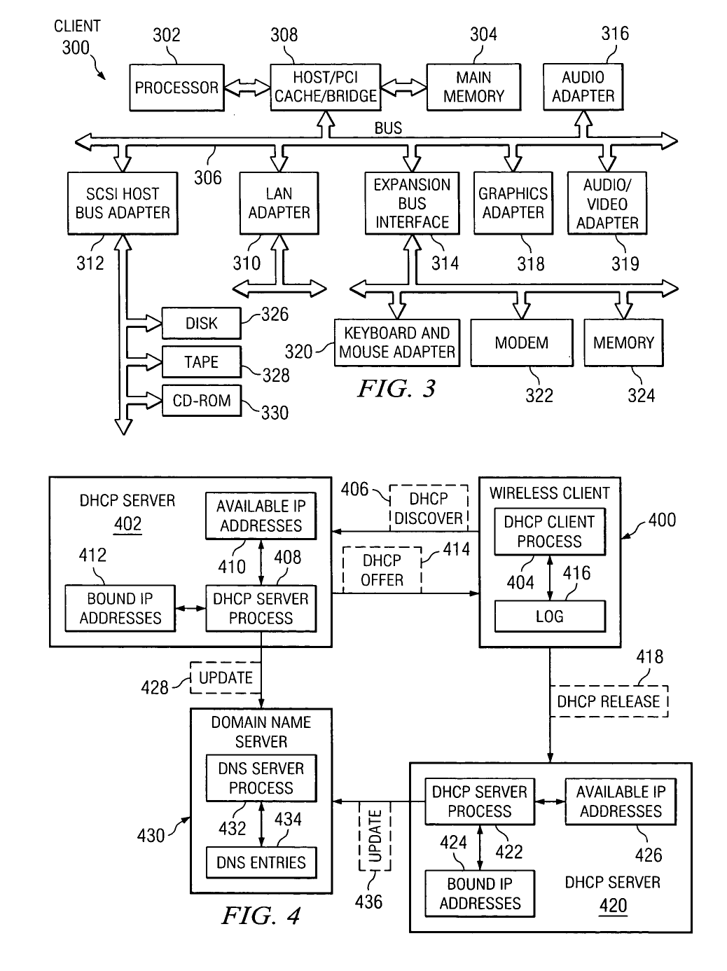

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302.

Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides an improved method, apparatus, and computer instructions for managing IP address and name mappings for clients. The mechanism of the present invention provides for the clean up of unused IP address and name mappings. This mechanism provides for releasing these addresses and entries prior to the expiration of a lease time to allow for quicker reuse of these resources. This mechanism is implemented without requiring modification to the current DHCP protocol, which is described in more detail in RFC 2131. Included in the client DHCP process is an extension that checks to determine whether the broadcast message is received by the same server from which an IP address was previously obtained. If the DHCP server is the same server, no other steps are taken. If the DHCP server is a different server, a packet is sent to the old server when a new address is obtained.

More specifically, the DHCP client tracks the last used DHCP server and IP address. When the DHCP client sees that an offer for an IP address is made, the client checks the offer against the log. If the offer is a new IP address but from the same DHCP server, no other steps are taken. If the offer is a new IP address from a different DHCP server, the client will send a packet to the prior DHCP server containing the old IP address to be released. This packet causes the DHCP server to free that IP address even if the lease period has not expired. Further, the DHCP server will free entries in a domain name server, which may be automatically called when the DHCP server receives the request to release the IP address.

Turning next to FIG. 4, a diagram illustrating components used in managing IP address and domain name service entries is depicted in accordance with a preferred embodiment of the present invention. In this example, wireless client 400 may request an IP address from DHCP server 402. Wireless client 400 may be implemented using a data processing system, such as data processing system 300 in FIG. 3. DHCP server 402 may be implemented using a data processing system, such as data processing system 200 in FIG. 2.

Wireless client 400 includes DHCP client process 404, which is used to request and obtain an IP address from DHCP server 402. In particular, DHCP client process 404 sends DHCP discover message 406 to DHCP server process 408 in DHCP server 402. When this request is received, DHCP server process 408 selects an IP address from available IP addresses 410 or bound IP addresses 412.

If wireless client 400 had previously received an IP address from DHCP server 402, this IP address may be offered to wireless client 400 again. DHCP server process 408 checks bound IP addresses 412 to see whether wireless client 400 had previously received an IP address from DHCP server 402. Bound IP addresses 412 are IP addresses that have been assigned to clients and have lease periods that have not expired. When a lease period expires, the IP address is then returned to available IP addresses 410 from bound IP addresses 412. The IP address as well as other configuration information is returned to wireless client 400 through DHCP offer 414. DHCP client process 404 receives DHCP offer 414 and waits to be able to bind this address. When the address is bound, that address is stored in bound IP addresses 412.

Further, upon receiving DHCP offer 414, DHCP client process 404 checks log 416 and compares the server and IP address from DHCP offer 414 with a last used DHCP server and the last used IP address. If the offer is a new IP address from the same DHCP server, no additional steps are taken than those normally performed in obtaining an IP address from a DHCP server. If the IP address is a new address from a different DHCP server, DHCP client process 404 waits until it is able to bind the new address.

After DHCP client process 404 binds to the new address, DHCP client process 404 builds and sends DHCP release packet 418 to the previous DHCP server, DHCP server 420. DHCP server 420 may be implemented using a data processing system, such as data processing system 200. DHCP release 418 is received by DHCP server process 422 in DHCP server 420. In response to receiving this release message, the IP address is released from bound IP addresses 424 if the lease for the IP address has not yet expired. As a result, this IP address will then return to available IP addresses 426 to free this address up for assignment to another client.

Further, if wireless client 400 is to be accessible using a name in addition to an IP address, this name is sent to DHCP server 402, which will send update 428 to domain name system (DNS) server 430. Domain name system server 430 may be implemented using a data processing system, such as data processing system 200 in FIG. 2. DNS server process 432 takes the name and IP address from update 428 and creates an entry in DNS entries 434.

Previously, these DNS entries would not be removed until freed by the prior DHCP server, DHCP server 420 in this example. This release typically does not occur until the lease time had expired for the prior IP address assigned to wireless client 400. In the depicted examples, entries may be freed up from DNS entries 434 through the mechanism of the present invention.

Specifically, when DHCP release 418 is received by DHCP server process 422, update 436 is generated and sent to DNS server process 432 to indicate that a particular name and address mapping is no longer needed and may be removed from DNS entries 434. Thus, in this manner, the mechanism of the present invention allows for improved IP address and DNS entry management without the problems and complications of reducing lease times for IP addresses.

Although the DHCP server and the DNS system server are illustrated as separate machines, the DHCP server processes and DNS server processes may be located in the same physical machine depending on the particular implementation.

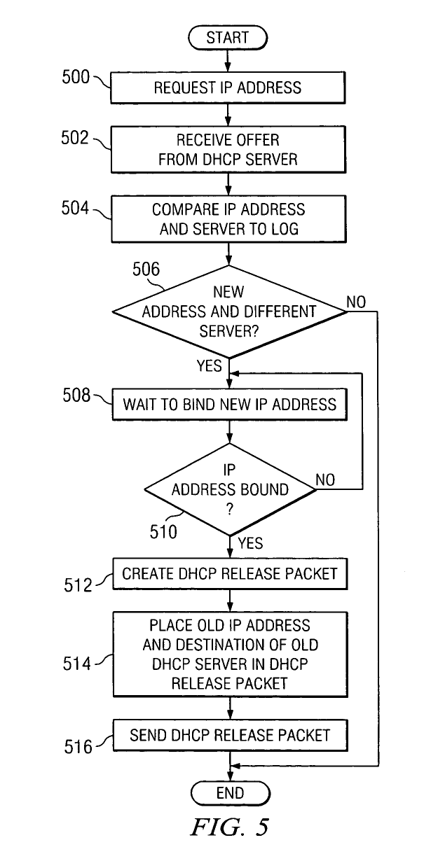

Turning now to FIG. 5, a flowchart of a process for requesting and managing IP addresses from a DHCP server is depicted in accordance with a preferred embodiment of the present invention. The process illustrated in FIG. 5 may be implemented in a client, such as wireless client 400 in FIG. 4.

The process begins by requesting an IP address (step 500). Thereafter, an offer is received from DHCP server (step 502). The IP address and the server are compared to a log (step 504). This log contains the previous IP address and the previous server offering the IP address to the client. A determination is made as to whether the offer is a new IP address from a different server (step 506). If the IP address is a new address from a different server, the process waits to bind the new IP address (step 508).

Next, a determination is made as to whether the IP address has been bound (step 510), if the address has not been bound, the process returns to step 508. Otherwise, a DHCP release packet is created (step 512). The old IP address and the destination of the old DHCP server are placed into the DHCP release packet (step 514).

Then, the DHCP release packet is sent (step 516) with the process terminating thereafter. This DHCP release packet causes the server that previously provided the IP address to the client to release that IP address from a bound or used set of IP addresses. With reference back to step 506, if the offer is not a new IP address from a different server, the process terminates.

As a result, that IP address is then available for reassignment. Further, if a name/address mapping had been created for the client, the DHCP server also will send an update to the DNS server to remove that entry.

Thus, the mechanism of the present invention provides an improved method, apparatus, and computer instructions for managing IP addresses that are dynamically allocated to clients. The mechanism of the present invention allows for freeing of an IP address prior to the expiration of the lease time. A client requesting an IP address will generate a packet requesting that an old IP address be released if the new address offered to the client comes from a different DHCP server. In this manner, IP addresses may be more efficiently managed in a DHCP server without requiring adjustments or tweaking of lease periods. Further, this mechanism also allows for the removal of unneeded DNS entries from a DNS server through the update process provided in the DHCP server.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method in a data processing system for managing network addresses, the method comprising:
comparing a received network address from a current server for use in identifying the data processing system with a prior network address from a previous server;
creating a release data packet if the received network address is a new network address and the previous server is a different server than the current server, wherein the release data packet includes the prior network address; and
sending the release data packet to the previous server, wherein the release data packet causes the previous server to release the prior network address for reuse.

2. The method of claim 1, wherein the current server and the prior server are dynamic host configuration protocol servers.

3. The method of claim 1 further comprising:
initiating the creating step only after the new network address has been bound to the data processing system.

4. The method of claim 1, wherein the network address is an Internet protocol address.

5. The method of claim 1, wherein the release data packet causes the previous server to send an update to a domain name server to delete an entry mapping the prior network address to a name for the data processing system.

6. The method of claim 1 further comprising:
storing the new network address and an identification of the current server in a log.

7. A data processing system for managing network addresses, the data processing system comprising:
a bus system;
a communications unit connected to the bus system;
a memory connected to the bus system, wherein the memory includes a set of instructions; and
a processing unit connected to the bus system, wherein the processing unit executes the set of instructions to compare a received network address from a current server for use in identifying the data processing system with a prior network address from a previous server; create a release data packet if the received network address is a new network address and the previous server is a different server than the current server in which the release data packet includes the prior network address; and send the release data packet to the previous server in which the release data packet causes the previous server to release the prior network address for reuse.

8. A data processing system for managing network addresses, the data processing system comprising:
comparing means for comparing a received network address from a current server for use in identifying the data processing system with a prior network address from a previous server;
creating means for creating a release data packet if the received network address is a new network address and the previous server is a different server than the current server, wherein the release data packet includes the prior network address; and
sending means for sending the release data packet to the previous server, wherein the release data packet causes the previous server to release the prior network address for reuse.

9. The data processing system of claim 8, wherein the current server and the prior server are dynamic host configuration protocol servers.

10. The data processing system of claim 8 further comprising:
initiating means for initiating the creating means only after the new network address has been bound to the data processing system.

11. The data processing system of claim 8, wherein the network address is an Internet protocol address.

12. The data processing system of claim 8, wherein the release data packet causes the previous server to send an update to a domain name server to delete an entry mapping the prior network address to a name for the data processing system.

13. The data processing system of claim 8 further comprising:
storing means for storing the new network address and an identification of the current server in a log.

14. A computer program product in a computer readable medium for managing network addresses, the computer program product comprising:
first instructions for comparing a received network address from a current server for use in identifying the data processing system with a prior network address from a previous server;
second instructions for creating a release data packet if the received network address is a new network address and the previous server is a different server than the current server, wherein the release data packet includes the prior network address; and
third instructions for sending the release data packet to the previous server, wherein the release data packet causes the previous server to release the prior network address for reuse.

15. The computer program product of claim 14, wherein the current server and the prior server are dynamic host configuration protocol servers.

16. The computer program product of claim 14 further comprising:
fourth instructions for initiating the creating step only after the new network address has been bound to the data processing system.

17. The computer program product of claim 14, wherein the network address is an Internet protocol address.

18. The computer program product of claim 14, wherein the release data packet causes the previous server to send an update to a domain name server to delete an entry mapping the prior network address to a name for the data processing system.

19. The computer program product of claim 14 further comprising:
fifth instructions for storing the new network address and an identification of the current server in a log.

20. The computer program product of claim 14, wherein the domain name server is located on a same data processing system as the previous server.
